(19) United States
(12) Patent Application Publication
(10) Pub. No.: US 2017/0161508 A1
(43) Pub. Date: Jun. 8, 2017

(54) MANAGEMENT DEVICE, METHOD EXECUTED BY THE MANAGEMENT DEVICE, AND NON-TRANSITORY COMPUTER-READABLE STORAGE MEDIUM

(71) Applicant: FUJITSU LIMITED, Kawasaki-shi (JP)

(72) Inventor: Taketoshi Yoshida, Kunitachi (JP)

(73) Assignee: FUJITSU LIMITED, Kawasaki-shi (JP)

(21) Appl. No.: 15/352,659

(22) Filed: Nov. 16, 2016

(30) Foreign Application Priority Data
Dec. 7, 2015 (JP) 2015-238953

(51) Int. Cl. G06F 21/60; G06F 17/30

(52) U.S. Cl. CPC G06F 21/604; G06F 17/30312; G06F 17/30339; G06F 17/3033; G06F 17/30477; G06F 17/30345

(57) ABSTRACT

A management device of a storage system in which a plurality of pieces of data is stored in a plurality of devices respectively, the management device includes a memory and a processor configured to acquire access information indicating access statuses to the plurality of pieces of data stored in the plurality of devices respectively, determine, based on the access information, first data of the plurality of pieces of data, which is to be moved from a first device of the plurality of devices to a second device of the plurality of devices, move the first data from the first device to the second device, register, in the first device, move data information that specifies the first data and move destination device information that specifies the second device, and register, in the second device, the move data information and move source device information that specifies the first device.

### CROSS-REFERENCE TO RELATED APPLICATION

This application is based upon and claims the benefit of priority of the prior Japanese Patent Application No. 2015-238953, filed on Dec. 7, 2015, the entire contents of which are incorporated herein by reference.

### FIELD

The embodiments discussed herein are related to a management device, a method executed by the management device, and a non-transitory computer-readable storage medium.

### BACKGROUND

A distributed database system in which, using key and value pairs, data is managed by a plurality of servers in a decentralized manner allocates a partial key space achieved by dividing a key space to each server to perform decentralized management. That is, each server stores data having a key included in the partial key space allocated to the own server. When referring to data, a key is obtained from data by hash calculation, a server storing the data is specified based on the key, and a data reference request is transferred to the specified server.

Note that, as an example of related art, there is the following technology. A management device acquires an identifier j of each of a plurality of processing devices and acquires, for each of one or more complete data sets i, an identifier (a data device list i) of each of one or more data devices that store data that belongs to the complete data set. Then, based on a communication load per unit data amount between each processing device and a corresponding data device, the identifiers of which have been acquired, each processing device calculates c′ij including a communication load cij with which the unit data amount of each complete data set is received from the data device in the data device list. Then, a communication amount fij, which is 0 or more, with which each processing device receives each complete data set, is determined such that the predetermined sum of values including fijc′ij is the smallest.

Also, as another example of related art, there is the following technology, too. Each node includes a first identifier used for obtaining a value range of target data that the own node is to hold and a second identifier used by a node that has received a message for determining a transfer route through which the node transfers the message to another node. Also, each node includes a holding section that holds target data which is in the value range determined based on the first identifier and is specified by a third identifier and a transfer section that determines the another node to which the message is to be transferred using route information including the second identifier. Then, in response to reception of at least one of the first to third identifiers at the own node, using the received identifier as a search key, the route information is referred to, and as a result, if there is another corresponding node, the transfer section transfers the message to the another node.

As still another example of related art, there is the following technology. In a distributed processing system including one or more distributed processing devices (nodes), a node that is to be a candidate, which is to be caused to perform a part of processing of which a certain node (a comparison node) takes charge, is a candidate node. Then, an acting node set that is caused to substitute for the candidate node to perform the whole processing of which the candidate node takes charge, using one or more nodes (acting nodes), is generated, and a predicted value (a post-substitution load predicted value) of a load after substitution of each acting node in the case where the acting node set substitutes for the candidate node to perform the processing of the candidate node is calculated. Then, if the post substitution load predicted value of each acting node satisfies a predetermined condition, the acting node set is caused to substitute for the candidate node to perform the processing of the candidate node and thus make the candidate node empty, and load distribution in which the candidate node that was made empty is caused to share a part of processing of which the comparison node takes charge is executed. International Publication Pamphlet No. WO2011/074699, Japanese Laid-open Patent Publication No. 2012-43330, and Japanese Laid-open Patent Publication No. 2013-149069.

### SUMMARY

According to an aspect of the invention, a management device of a storage system in which a plurality of pieces of data is stored in a plurality of devices respectively, the management device includes a memory and a processor coupled to the memory and configured to acquire access information indicating access statuses to the plurality of pieces of data stored in the plurality of devices respectively, determine, based on the access information, first data of the plurality of pieces of data, which is to be moved from a first device of the plurality of devices to a second device of the plurality of devices, move the first data from the first device to the second device, register, in the first device, move data information that specifies the first data and move destination device information that specifies the second device, and register, in the second device, the move data information and move source device information that specifies the first device.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a configuration of a distributed database system according to a first embodiment;

FIG. 2A is a chart illustrating a Chord system;

FIG. 2B is a chart illustrating a Kademlia system;

FIG. 3 is a diagram illustrating a move data routing table;

FIG. 4 is a diagram illustrating a functional configuration of a distributed database system according to the first embodiment;

FIG. 5 is a flowchart illustrating a flow of processing of a data management device according to the first embodiment;

FIG. 6 is a flowchart illustrating a flow of search processing;

FIG. 7 is a flowchart illustrating a flow of deletion processing;

FIG. 8A is a view illustrating an example of a matrix used by a specifying section for cost calculation;

FIG. 8B is a network physical configuration diagram based on which a matrix is created;

FIG. 8C is a view illustrating a cost calculation method;

FIG. 8D is a chart illustrating an output amount and an input amount;

FIG. 8E is a table illustrating calculation results for output load and input load of each server;

FIG. 8F is a table illustrating deviation value calculation results;

FIG. 9 is a diagram illustrating a functional configuration of the specifying section;

FIG. 10 is a flowchart illustrating a flow of processing performed by a data management device according to a second embodiment;

FIG. 11 is a flowchart illustrating a flow of processing performed by a specifying section;

FIG. 12 is a flowchart illustrating a flow of processing of matrix construction;

FIG. 13 is a flowchart illustrating a flow of processing of data collection;

FIG. 14 is a flowchart illustrating a flow of processing of bias determination;

FIG. 15 is a flowchart illustrating a flow of processing of move determination;

FIG. 16 is a flowchart illustrating a flow of processing of specifying move data;

FIG. 17 is a flowchart illustrating a flow of server specifying processing;

FIG. 18 is a flowchart illustrating a flow of low-load data move processing;

FIG. 19 is a diagram illustrating a hardware configuration of a computer that executes a data management program according to an embodiment; and

FIG. 20 is a diagram illustrating change of a key range that is managed for each server.

### DESCRIPTION OF EMBODIMENTS

In a distributed database system in which, using key and value pairs, data is managed by a plurality of servers in a decentralized manner, when the number of accesses to one server is much larger than those of other servers, as one of measures for the low load of the server, data is moved. However, when data is moved to another server, a key range that is managed for each server is desired to be changed.

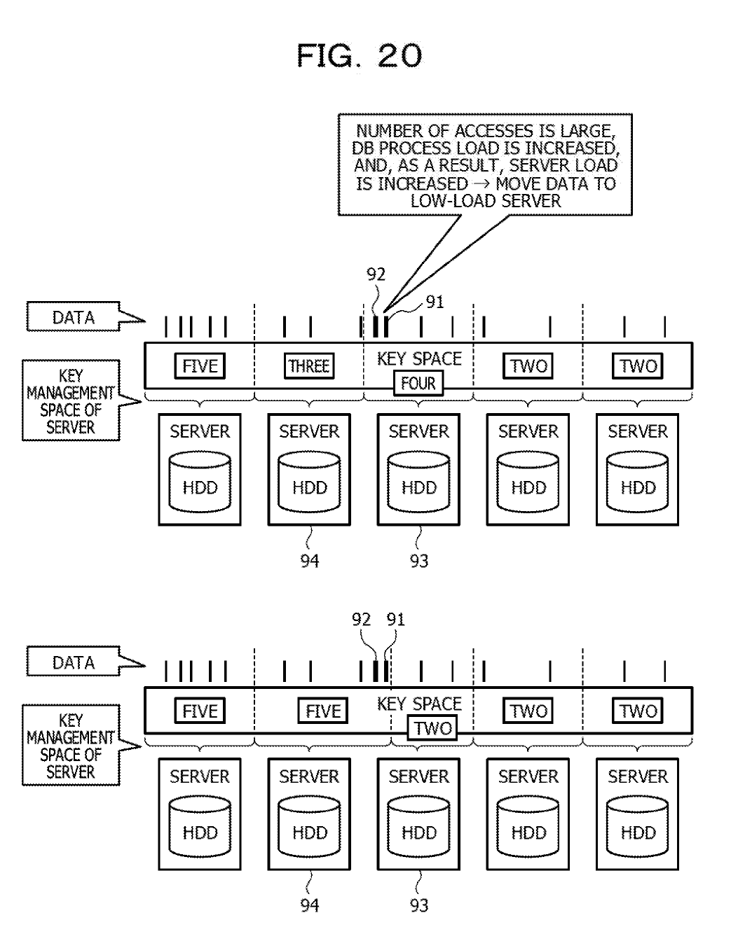

FIG. 20 is a diagram illustrating change of a key range that is managed for each server. FIG. 20 illustrates a case where a key space is divided by five servers. As illustrated in FIG. 20, when the number of accesses to data 91 that is managed by a server 93 is large, the database (DB) process load (a load of database processing) of the server 93 is increased, and the load of the server 93 is increased, the data 91 is moved to a server 94 with a low load. In this case, the key range that is managed for each server is continuous, and therefore, data 92 is also moved with the data 91. Then, a key range that is managed by the server 93 and a key range that is managed by the server 94 are changed.

Each server includes a routing table in which the key range that is managed by the server is registered, and therefore, when the key range that is managed by each server is changed, the routing table of each server is changed. Accordingly, a problem arises in which, when the data 91 is moved, it takes time to move the related data 92 and update the routing table.

Embodiments of a data management program and a data management method disclosed herein will be described below in detail with reference to the accompanying drawings. Note that embodiments below are not intended to limit a technology disclosed herein.

### FIRST EMBODIMENT

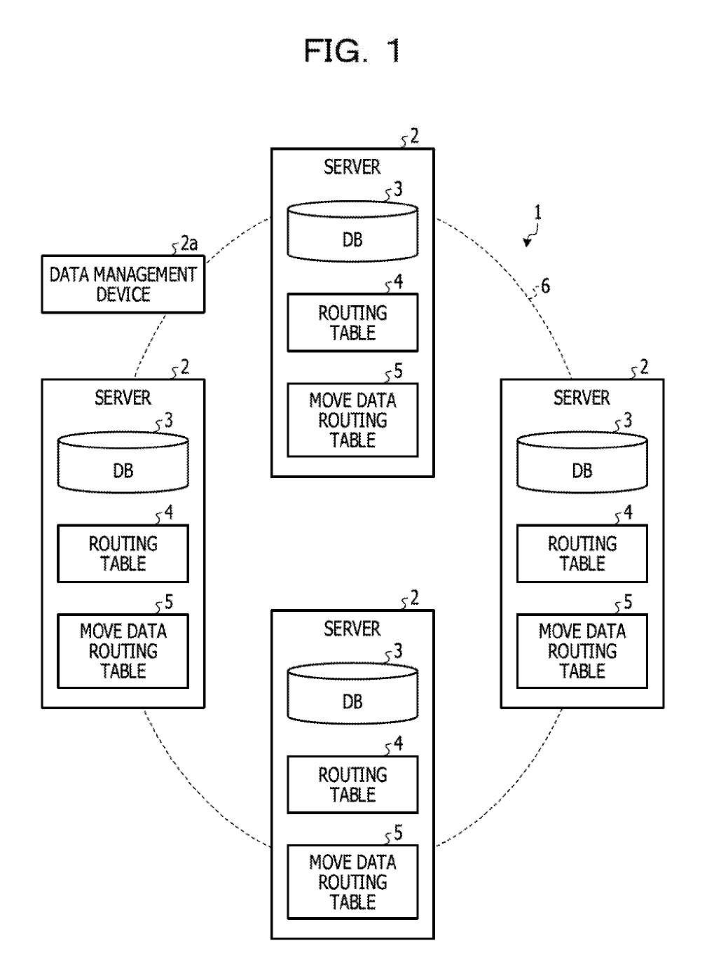

First, a configuration of a distributed database system according to a first embodiment will be described. FIG. 1 is a diagram illustrating a configuration of a distributed database system according to the first embodiment. As illustrated in FIG. 1, a distributed database system 1 according to the first embodiment includes a plurality of servers 2 and a data management device 2a. The plurality of servers 2 and the data management device 2a are coupled to one another via a network 6. Note that, in FIG. 1, the distributed database system 1 includes four servers 2, but may include an arbitrary number of servers 2 included in a cloud system or the like. Also, the network 6 is, for example, a local area network (LAN).

Each of the servers 2 is a device that shares data with the other servers 2 and manages the data, and includes a DB 3, a routing table 4, and a move data routing table 5. The DB 3 stores data in the key range of which the corresponding server 2 takes charge. The routing table 4 is a table in which key ranges that are managed by some of the servers 2, including the corresponding server 2, are registered in association with identifiers of the servers 2. Examples of the routing system using the routing table 4 include a Chord system, a Kademlia system, or the like.

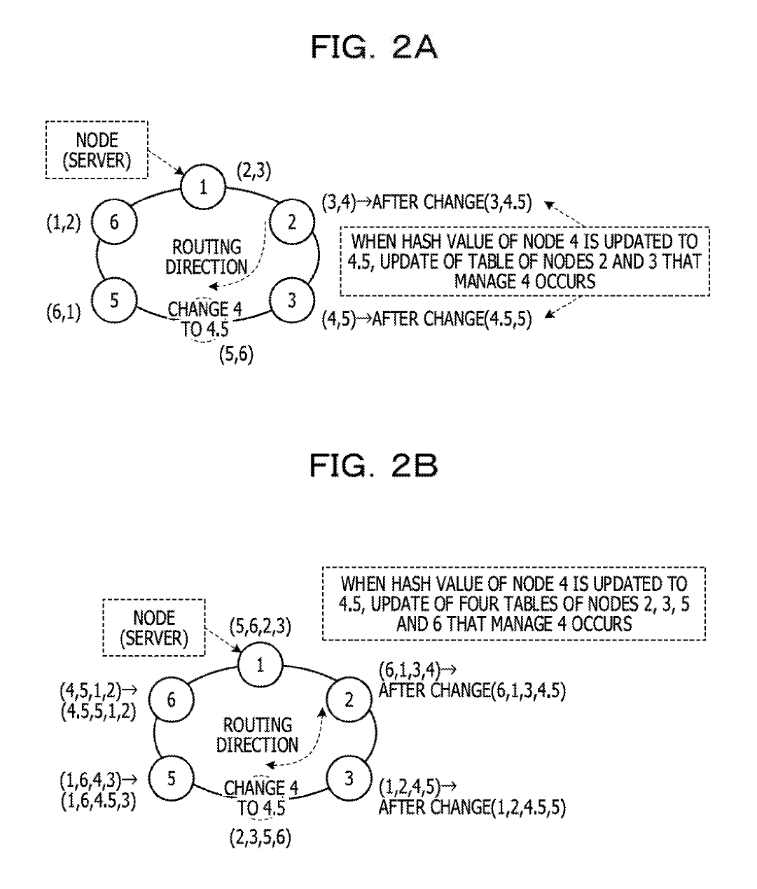

FIG. 2A is a chart illustrating a Chord system. In the Chord system, a hash value is allocated to each of the servers 2 and the servers 2 are sorted in descending order of the hash value. In FIG. 2A, each of hash values 1 to 6 is allocated to the corresponding one of six servers 2 and each of the six servers 2 is indicated by a node of the corresponding one of the allocated hash values.

Then, the hash value is also allocated to data that is registered therein, and the data is registered in one of the servers 2, which has the closest hash value among the hash values that have been allocated to the servers 2 to the allocated hash value of the data, in a descending order direction. For example, when the hash value of data is 1.5, the server 2 which has the closest hash value to the allocated hash value of the data in a descending order direction is a node #1. In this case, the node #1 is a node the allocated hash value of which is 1.

Each server 2 manages, for a predetermined number of the servers 2, the routing table 4 in which each hash value and the identifier of the corresponding server 2 are associated with one another in a direction of an ascending order of the hash value such that it is possible to reach the server 2 that stores data via several servers 2. For example, the node #1 manages, for a node #2 and a node #3, the identifier of the server 2, using the routing table 4. In FIG. 2A, (m, n) adjacent to each node indicates that the adjacent node manages the identifiers of a node #m to a node #n using the routing table 4.

For example, when the node #1 is requested to acquire data of a hash value 4.3, it is possible to reach the node #3, based on the routing table 4 of the node #1. Then, it is possible to reach the node #4 that stores the data of a hash value 4.3, based on the routing table 4 of the node #3. That is, in the Chord system, routing is performed in a direction indicated by a broken line arrow in FIG. 2A. Also, when the hash value of the node #4 is updated to 4.5, the routing tables 4 of the node #2 and the node #3 that manage the node #4 are updated.

FIG. 2B is a chart illustrating a Kademlia system. In the Kademlia system, each server 2 manages, for some of the servers 2, the identifiers of the servers 2 in two directions of an ascending order and a descending order of the hash value, using the routing table 4. Therefore, in the Kademlia system, each server 2 is managed such that it is possible to reach the server 2 that stores data in shorter time than that in the Chord system. For example, the node #1 manages, for the node #2 and the node #3 in an ascending direction and the node #5 and the node #6 in a descending direction, the identifiers of the servers 2, using the routing table 4. In FIG. 2B, (i, j, m, n) adjacent to each node indicate that the adjacent node manages the identifiers of a node #i to a node #j and a node #m to a node #n using the routing table 4.

For example, when the node #1 is requested to acquire data of a hash value 5.3, it is possible to reach the node #5 that stores the data of the hash value 5.3, based on the routing table 4 of the node #1. In the Kademlia system, as indicated by a broken line arrow in FIG. 2B, routing is bidirectionally performed. Also, when the hash value of the node #4 is updated to 4.5, the routing tables 4 of four nodes, that is, the node #2, the node #3, the node #5, and the node #6, which manage the node #4, are updated.

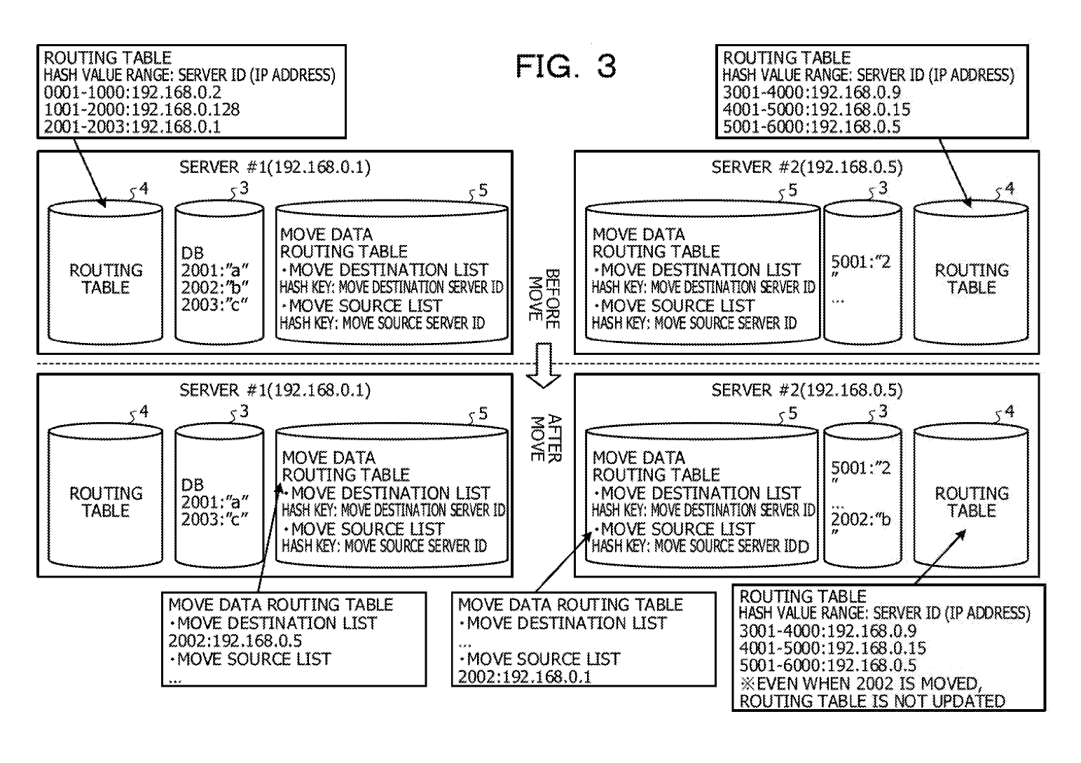

Returning to FIG. 1, the move data routing table 5 is a table in which information related to data that has been moved is registered. FIG. 3 is a diagram illustrating the move data routing table 5. FIG. 3 illustrates a case where data “b” stored in the DB 3 of a server #1 is moved to a server #2. The IP address of the server #1 is “192.168.0.1” and the IP address of the server #2 is “192.168.0.5”. The IP addresses are used as server IDs, that is, identifiers that identify the servers 2. The hash value of the data “b” is “2002”.

In the routing table 4 of the server #1, as a hash value range of an own server, “2001-2003” is registered. Also, in the routing table 4 of the server #1, as the hash value range of the IP address “192.168.0.2”, “0001-1000” is registered and, as the hash value range of the IP address “192.168.0.128”, “1001-2000” is registered. In the routing table 4 of the server #2, as the hash value range of the own server, “5001-6000” is registered. Also, in the routing table 4 of the server #2, as the hash value range of the IP address “192.168.0.9”, “3001-4000” is registered and, as the hash value range of the IP address “192.168.0.15”, “4001-5000” is registered. These routing tables 4 are not updated even after the data “b” is moved.

The move data routing table 5 includes a move destination list and a move source list. The move destination list is a list of pairs of hash keys and move destination server IDs. The “hash key” used herein is a hash value. The move source list is a list of pairs of hash keys and move source server IDs. When the data “b” is moved from the server #1 to the server #2, the hash key “2002” of the data “b” and the IP address “192.168.0.5” of the server #2 are added to the move destination list of the serve #1. Also, the hash key “2002” of the data “b” and the IP address “192.168.0.1” of the server #1 are added to the move source list of the server #2.

As described above, information related to data that has been moved is registered in the move data routing table 5, and thus, the distributed database system 1 may omit update of the routing table 4.

Returning to FIG. 1, the data management device 2a acquires the load of each server 2 and specifies the server 2 with a high load, data that is to be moved, and a move destination server 2. Then, the data management device 2a instructs the move source server 2 and the move destination server 2 to move data and update the move data routing table 5.

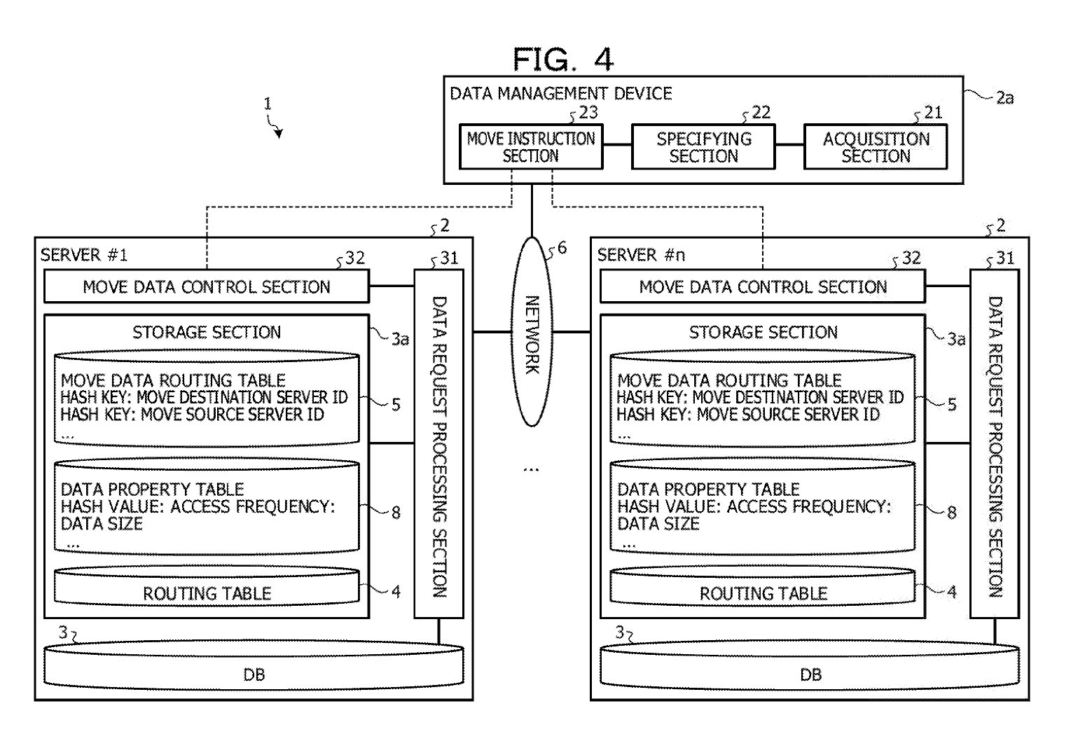

Next, a functional configuration of the distributed database system 1 according to the first embodiment will be described. FIG. 4 is a diagram illustrating a functional configuration of the distributed database system 1 according to the first embodiment. In FIG. 4, the distributed database system 1 includes n servers 2. As illustrated in FIG. 4, the server 2 includes the DB 3, a storage section 3a, a data request processing section 31, and a move data control section 32. The data management device 2a includes an acquisition section 21, a specifying section 22, and a move instruction section 23.

The storage section 3a stores data used for managing data of which the server 2 takes charge. The storage section 3a stores the routing table 4, the move data routing table 5, and a data property table 8. The data property table 8 associates an access frequency and a data size with a hash value. The access frequency is the number of writes and the number of reads.

The data request processing section 31 processes a data access request that is sent from a client device or another server 2 via the network 6, using the storage section 3a. Specifically, the data request processing section 31 processes the data access request with reference to the routing table 4 and the move data routing table 5. Also, the data request processing section 31 updates the data property table 8, based on the processed data access request. Also, the data request processing section 31 moves data, based on an instruction of the move data control section 32.

The move data control section 32 performs control related to move of data between the servers 2, based on an instruction of the data management device 2a. Specifically, the move data control section 32 instructs the data request processing section 31 to perform move of data instructed by the data management device 2a. Also, the move data control section 32 updates the move data routing table 5, based on move data.

The acquisition section 21 acquires, for each hash value, the access frequency and the data size from each server 2 in certain time intervals. The specifying section 22 specifies data that is to be moved, a move source, and a move destination of the data, based on the access frequency, the data size, or the like, for each hash value, which have been acquired by the acquisition section 21. The move instruction section 23 instructs the data move source server 2 and the data move destination server 2 to move data specified by the specifying section 22 and update the move data routing table 5.

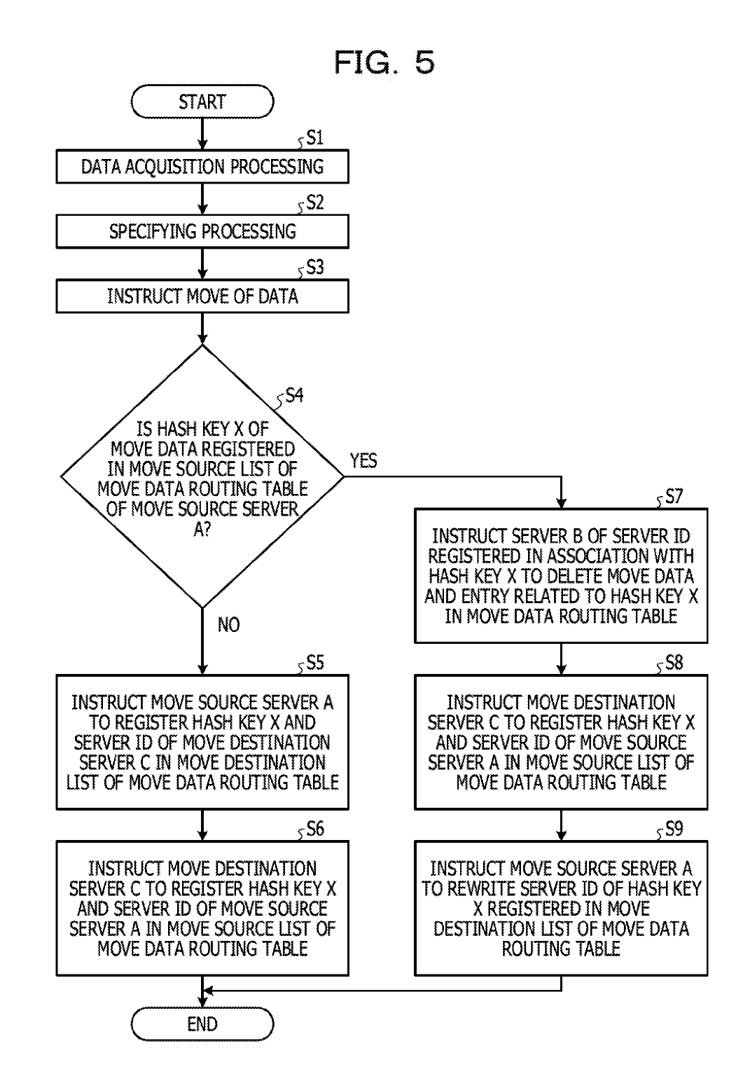

Next, a flow of processing of the data management device 2a according to the first embodiment will be described. FIG. 5 is a flowchart illustrating of a flow of processing of the data management device 2a according to the first embodiment. As illustrated in FIG. 5, the acquisition section 21 performs data acquisition processing of acquiring, for each hash value, the access frequency and the data size from each server 2 in certain time intervals (Step S1).

Then, the specifying section 22 performs specifying processing of specifying, based on the access frequency and the data size acquired for each hash value or the like, data that is to be moved and a move destination of the data (Step S2). Then, the move instruction section 23 instructs a move source server 2 and a move destination server 2 to move data (Step S3). Note that, in the following description, the move source server 2 is a move source server A and the move destination server 2 is a move destination server C. Also, if the data was previously moved, the move destination server 2 is a server B.

Then, the move instruction section 23 determines whether or not a hash key X of move data is registered in the move source list of the move data routing table 5 of the move source server A by inquiring of the move source server A (Step S4). As a result, if the hash key X of move data is not registered, the move instruction section 23 instructs the move source server A to register the hash key X and the server ID of the move destination server C in the move destination list of the move data routing table 5 (Step S5). Then, the move instruction section 23 instructs the move destination server C to register the hash key X and the server ID of the move source server A in the move source list of the move data routing table 5 (Step S6).

On the other hand, if the hash key X is registered, the move instruction section 23 instructs the server B of the server ID that has been registered in association with the hash key X to delete the move data and an entry related to the hash key X in the move data routing table 5 (Step S7). Then, the move instruction section 23 instructs the move destination server C to register the hash key X and the server ID of the move source server A in the move source list of the move data routing table 5 (Step S8). Then, the move instruction section 23 instructs the move source server A to rewrite the server ID of the hash key X registered in the move destination list of the move data routing table 5 to the move destination server C (Step S9).

As described above, the move instruction section 23 instructs the move source server A and the move destination server C to move data and update the move data routing table 5 and instructs the server B to delete data and update the move data routing table 5. Therefore, the data management device 2a may omit update of the routing table 4 and move of data that is not used.

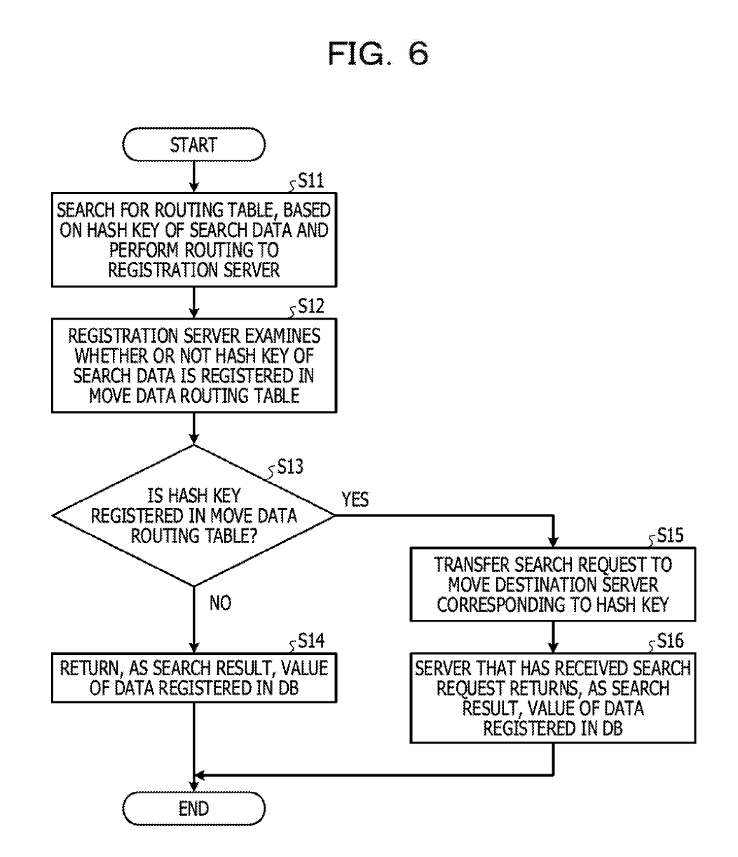

Next, a flow of search processing will be described. FIG. 6 is a flowchart illustrating a flow of search processing. As illustrated in FIG. 6, the server 2 that has received a data search request from a client server searches for the routing table 4, based on a hash key of search data, and performs routing to a registration server 2 in which data is registered in cooperation with a routing destination (Step S11).

Then, the registration server 2 examines whether or not the hash key of search data is registered in the move data routing table 5 (Step S12). Then, the registration server 2 determines whether or not the hash key of search data is registered in the move data routing table 5 (Step S13) and, if the hash key is not registered therein, the registration server 2 returns, as a search result, the value of data registered in the DB 3 (Step S14).

One the other hand, if the hash key of search data is registered in the move data routing table 5, the registration server 2 transfers a search request to the move destination server 2 corresponding to the hash key (Step S15). Then, the server 2 that has received the search request returns, as a search result, the value of data registered in the DB 3 (Step S16).

As described above, the server 2 that has received a data search request transfers the search request to another server 2 that stores data with reference to the move data routing table 5, and thus, the data management device 2a may omit update of the routing table 4. Note that, if a data correction request is received from the client device, the distributed database system 1 performs processing in accordance with a similar flow, except a point that, in Step S14 and Step S16, the distributed database system 1 corrects the DB 3 and returns correction completion, instead of returning a search result.

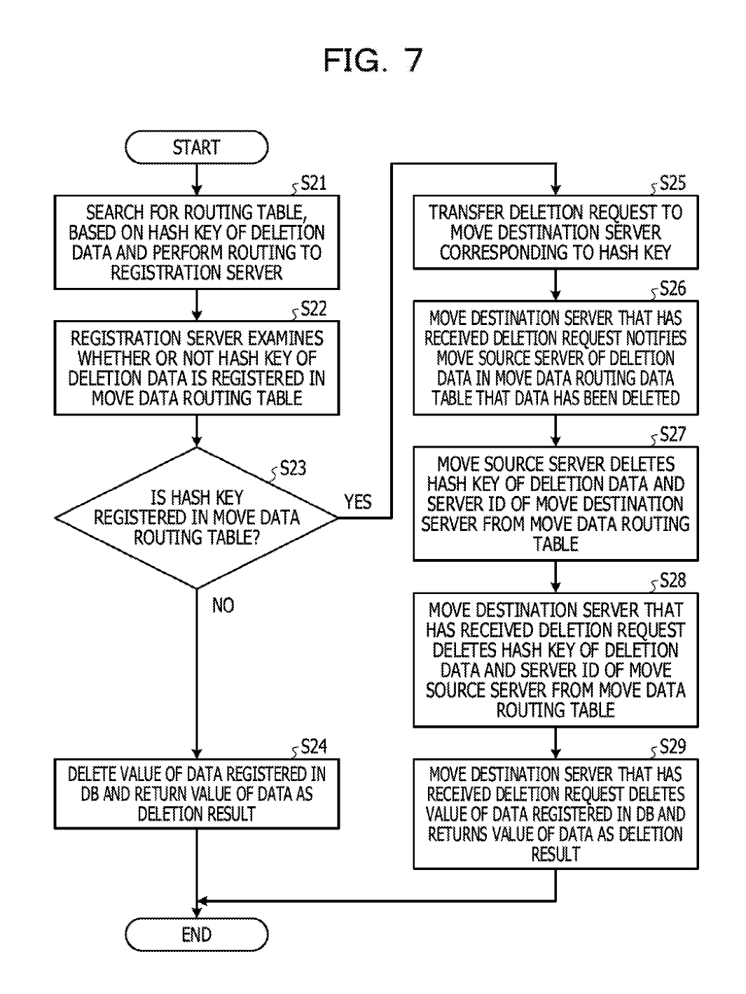

Next, a flow of deletion processing will be described. FIG. 7 is a flowchart illustrating a flow of deletion processing. As illustrated in FIG. 7, the server 2 that has received a data deletion request from the client device searches for the routing table 4, based on the hash key of deletion data, and performs routing to the registration server 2 in which data is registered in cooperation with a routing destination (Step S21).

Then, the registration server 2 examines whether or not the hash key of deletion data is registered in the move data routing table 5 (Step S22). Then, the registration server 2 determines whether or not the hash key is registered in the move data routing table 5 (Step S23) and, if the hash key is not registered therein, the registration server 2 deletes the value of data registered in the DB 3 and returns the value of data as a deletion result (Step S24).

On the other hand, if the hash key is registered in the move data routing table 5, the registration server 2 transfers the deletion request to the move destination server 2 corresponding to the hash key (Step S25). Then, the registration server 2 that has received the deletion request notifies the move source serve 2 of deletion data of the move data routing table 5 that data has been deleted (Step S26).

Then, the move source server 2 deletes the hash key of deletion data and the server ID of the move destination server 2 from the move data routing table 5 (Step S27). Then, the move destination serve 2 that has received the deletion request deletes the hash key of deletion data and the server ID of the move source server 2 from the move data routing table 5 (Step S28). Then, the move destination server 2 that has received the deletion request deletes the value of data registered in the DB 3 and returns the value of data as a deletion result (Step S29).

As described above, when data is moved, the move destination server 2 deletes the data and the move source server 2 and the move source server 2 delete information related to deletion data from the move data routing table 5. Therefore, the distributed database system 1 may delete information that is no longer used from the move data routing table 5.

As has been described above, in the first embodiment, the move instruction section 23 of the data management device 2a instructs the move source server 2 and the move destination server 2 to move data and also update the move data routing table 5. Then, the move data control sections 32 of the move source server 2 and the move destination server 2 control move of data and also update the move data routing table 5 in relation to move data. Therefore, the distributed database system 1 may omit move of data other than move data and update of the routing table 4, so that a processing time of data move may be reduced.

### SECOND EMBODIMENT

In a second embodiment, as an example of the specifying section 22, a specifying section 22a that specifies move data, the move source server 2, and the move destination server 2 by performing cost calculation using a matrix will be described. In this case, the term “cost” used herein is a processing load of the distributed database system 1. The costs include a data access cost between the servers 2, a network cost, and a server cost. The specifying section 22a specifies move data, the move source server 2, and the move destination server 2 such that the costs of the distributed database system 1 are minimum, that is, the performance of the distributed database system 1 is maximum.

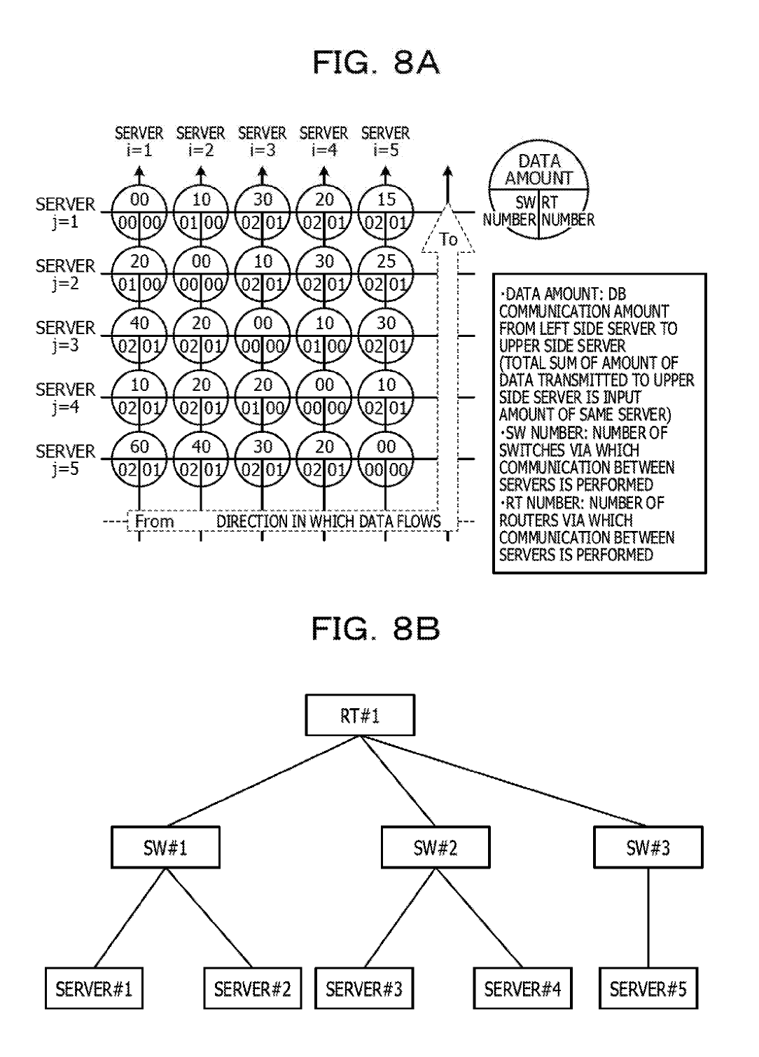

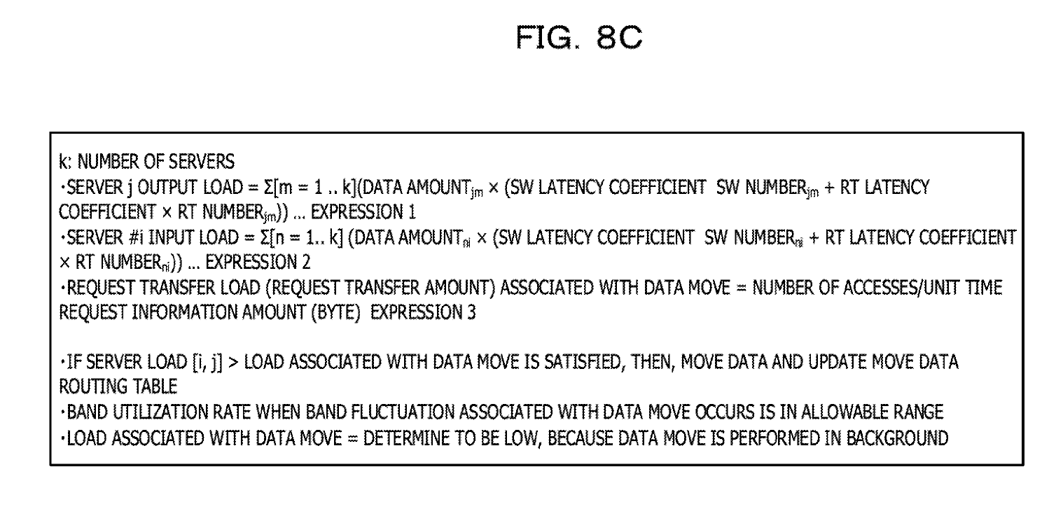

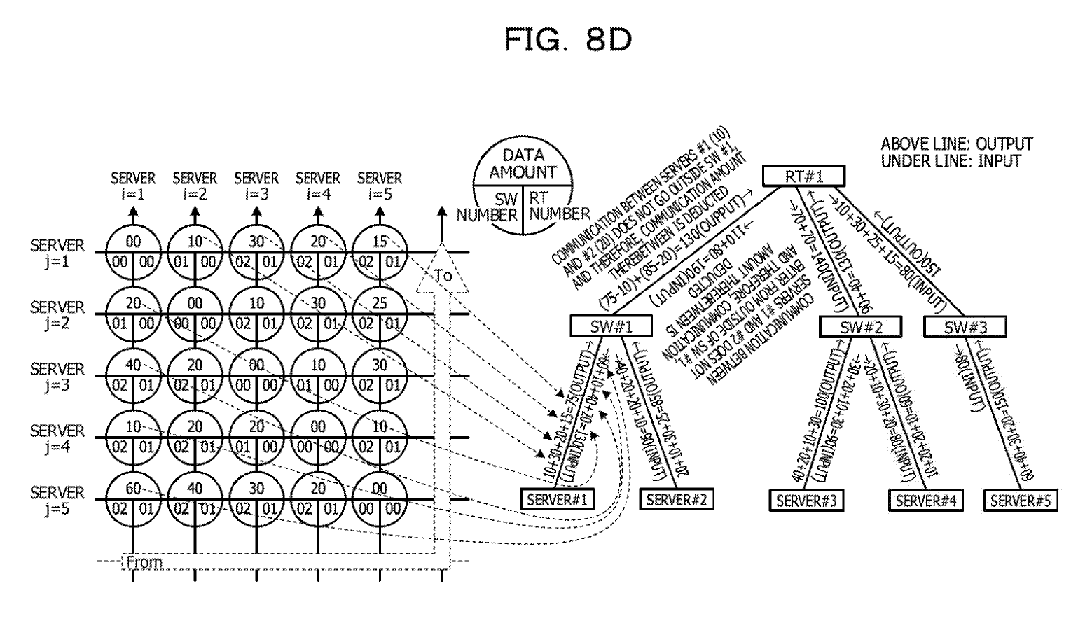

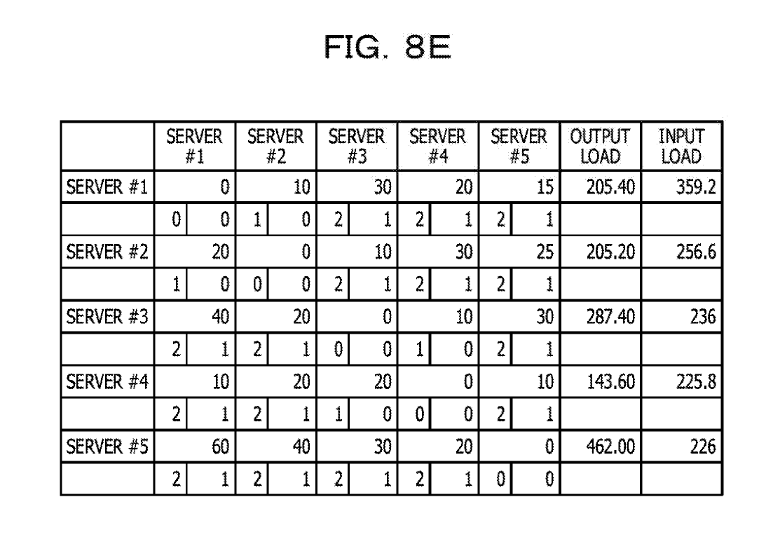

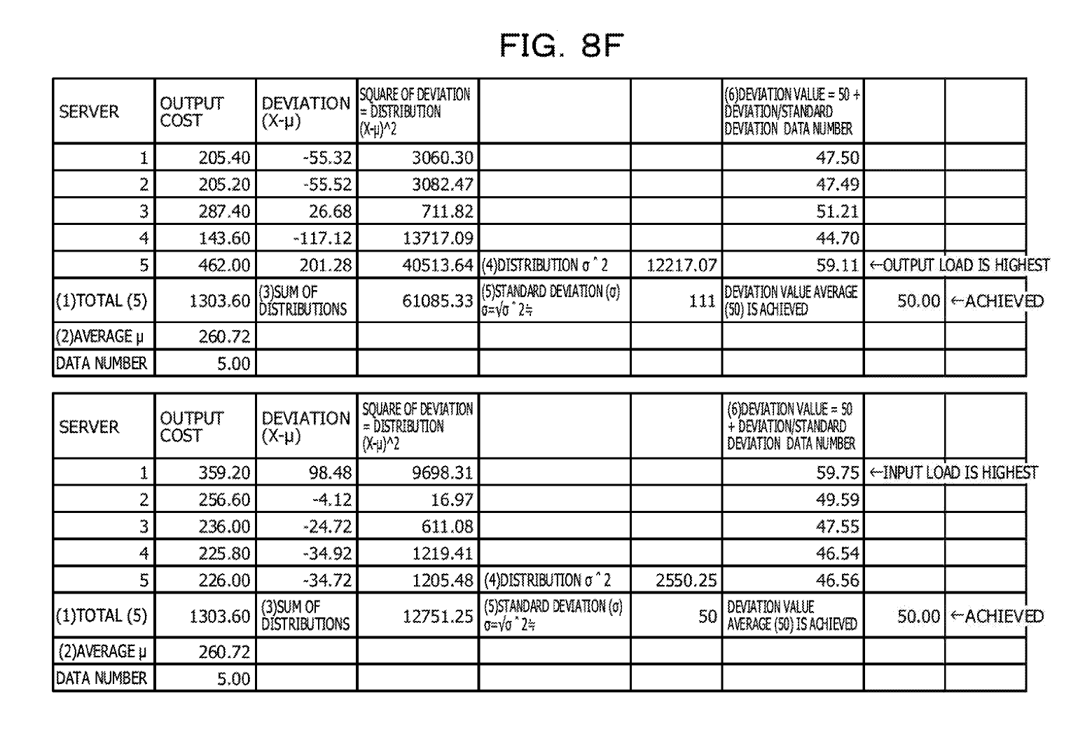

FIG. 8A to FIG. 8F illustrate a cost calculation method using a matrix. FIG. 8A is a view illustrating an example of a matrix used by the specifying section 22a for cost calculation and FIG. 8B is a network physical configuration diagram based on which a matrix is created. In FIG. 8B, RT#1 denotes a router and SW#1 to SW#3 denote switches. As illustrated in FIG. 8B, five servers 2 represented by servers #1 to #5 are coupled to one another via the three switches and the router.

As illustrated in FIG. 8A, a matrix is created by disposing the five servers 2 in longitudinal and lateral directions. In an element located in a row j and a column i, the amount of data transmitted from a server #j to a server #i and the number of switches (SW) and the number of routers (RT) on a route from the server #j to the server #i are indicated.

The data amount is indicated in an upper half of a circle representing each element of the matrix and represents the amount of DB communication from a left side server 2 to an upper side server 2. The unit thereof is megabyte (MB). The total sum of the amount of data transmitted to the server upper side 2 is the input amount of the server 2, and the total sum of the amount of data transmitted from the left side server 2 is the output amount of the server 2. The SW number is indicated in a lower left half of the circle representing each element of the matrix and the RT number is indicated in a lower right half of the circle representing each element of the matrix.

For example, as for communication from the server #2 to the server #1, the amount of DB communication is 20 MB, the number of switches via which the DB communication is performed is 1, and the number of routers via which the DB communication is performed is 0. The input amount of the server #1 is the total sum of the amount of data of one column, that is, 20+40+10+60=130 MB. The output amount of the server #1 is the total sum of the amount of data of one row, that is, 10+30+20+15=75 MB.

FIG. 8C is a view illustrating a cost calculation method. As illustrated in FIG. 8C, assuming that the number of servers is k, the output load of the server #j is defined as SERVER #j OUTPUT LOAD=Σ[m=1 . . . k](DATA AMOUNTⱼₘ×(SW LATENCY COEFFICIENT×SW NUMBERⱼₘ+RT LATENCY COEFFICIENT×RT NUMBERⱼₘ)) in accordance with Expression 1. In Expression 1, SW LATENCY COEFFICIENT is a coefficient representing a delay caused by a switch and RT LATENCY COEFFICIENT is a coefficient representing a delay caused by a router. Also, the input load of the server #i is defined as SERVER #i INPUT LOAD=Σ[n=1 . . . k] (DATA AMOUNTₙᵢ×(SW LATENCY COEFFICIENT×SW NUMBERₙᵢ+RT LATENCY COEFFICIENT×RT NUMBERₙᵢ)) in accordance with Expression 2.

Also, as for a request transfer load associated with data move, a time which it takes to transfer a request to a move destination is defined as REQUEST TRANSFER LOAD (REQUEST TRANSFER AMOUNT) ASSOCIATED WITH DATA MOVE=NUMBER OF ACCESSES/UNIT TIME×REQUEST INFORMATION AMOUNT (BYTE) in accordance with Expression 3.

Then, if a server load [i, j] is larger than the request transfer amount, it is determined that it is appropriate to move data and update the move data routing table 5. In this case, the server load [i, j] is a data transfer load from the server #j to the server #i. Also, a band utilization rate when band fluctuation associated with data move occurs is desired to be in an allowable range. Note that data move is performed in a background, and therefore, it is determined that a load associated with data move is low.

FIG. 8D is a chart illustrating an output amount and an input amount. In a network physical configuration diagram of FIG. 8D, a value above a line connecting each of the servers 2 and the corresponding switch to one another indicates the output amount of the server 2 and a value under the line indicates the input amount of the server 2. Also, a value above a line connecting each of the switches and the corresponding router to one another indicates the output amount of the switch and a value under the line indicates the input amount of the switch.

Since communication between the servers 2 coupled to the switch does not have any influence on the outside of the switch, the output amount of the switch is a result of deduction of the amount of communication between the coupled servers 2 from the total sum of the output amount of the coupled servers 2. Also, since communication between the coupled servers 2 is not affected by the influence of the outside of the switch, the input amount of the switch is a result of deduction of the amount of communication between the coupled servers 2 from the total sum of the input amount of the coupled servers 2.

For example, the output amount of the switch #1 is (the output amount of the server #1−the amount of communication from the server #1 to the server #2)+(the output amount of the server #2−the amount of communication from the server #2 to the server #1)=(75−10)+(85−20)=65+65=130. Also, the input amount of the switch #1 is (the input amount of the server #1−the amount of communication from the server #2 to the server #1)+(the input amount of the server #2−the amount of communication from the server #1 to the server #2)=(130−20)+(90−10)=110+80=190.

FIG. 8E is a table illustrating calculation results for output load and input load of each server 2. The output load of each server 2 is calculated using the output amount of each server 2 indicated in FIG. 8D and Expression 1 indicated in FIG. 8C, and the input load of each server 2 is calculated using the input amount of each server 2 indicated in FIG. 8D and Expression 2 indicated in FIG. 8C. Note that, in this case, the SW latency coefficient and the RT latency coefficient are 0.01 and 0.012, respectively.

The specifying section 22a specifies, after calculating the output load and the input load of each server 2, the server 2 the load of which is high. In FIG. 8E, the output load of the server #5 is the highest. Then, the specifying section 22a specifies the server 2 the load of which is the second highest. In FIG. 8E, the input load of the server #1 is high. Therefore, when data on the server #5 is moved to the server #1, the output load of the server #5 is reduced. Therefore, if there is an enough room in a hard disk drive (HDD) that stores the DB 3 in the server #1, the specifying section 22a determines to move the data on the server #5 to the server #1 and, if there is not enough room in the HDD, the specifying section 22a determines to move the data on the server #5 to another server 2.

Assuming that there is not enough room in the HDD of the server #1, the server #2 that has a shortest path to the server #1 is a candidate of a move destination. If there is an enough room in a band between the server #2 and the SW #1, the specifying section 22a determines to move the data on the server #5 to the server #2. If there is not an enough room in a band between the server #2 and the SW #1 and there is an enough room in each of a band between the RT #1 and the SW #2 and in a band between the SW #2 and the server #4, the specifying section 22a determines to move the data on the server #5 to the server #4.

Note that the specifying section 22a uses a deviation value in specifying the server 2 the load of which is high. FIG. 8F is a table illustrating deviation value calculation results. Each of output deviation values and input deviation values in FIG. 8F was calculated, based on the corresponding one of the output loads and the input loads. As illustrated in FIG. 8F, for the output load, the deviation value of the server 5 is the highest and, for the input load, the deviation value of the server #1 is the highest.

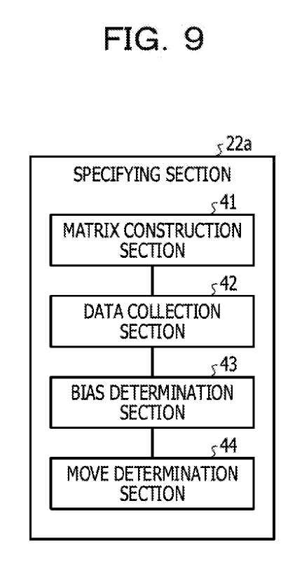

Next, a functional configuration of the specifying section 22a will be described. FIG. 9 is a diagram illustrating a functional configuration of the specifying section 22a. As illustrated in FIG. 9, the specifying section 22a includes a matrix construction section 41, a data collection section 42, a bias determination section 43, and a move determination section 44.

The matrix construction section 41 creates a matrix that is used by the specifying section 22a for cost calculation. The matrix construction section 41 creates a matrix, based on network physical configuration information or management information base (MIB) information including device coupling information of a switch and a router, or the like.

The data collection section 42 acquires the transmission data amount for data communicated between the servers 2 from each server 2 in certain cycles and reflects the acquired transmission data amount to the matrix.

The bias determination section 43 calculates, based on the matrix, each of the output load and the input load of each server 2, using Expression 1 and Expression 2 indicated in FIG. 8C, and calculates the deviation values of the output load and the input load of each server 2. Then, the bias determination section 43 determines, by comparing each of the deviation values of the output load and the input load of each server 2 with the corresponding predetermined threshold, whether or not there is a bias and specifies, as the move source server 2, the server 2 the bias of which is the largest.

The move determination section 44 instructs the move source server 2 specified by the bias determination section 43 to specify move data. Then, the move determination section 44 performs determination, using, as move conditions, whether or not the load of the distributed database system 1 is reduced by move of data and whether or not a band of a related part of the network 6 is in an allowable range by move of data. Then, if the move conditions are satisfied, the move determination section 44 determines to move data and, if the move conditions are not satisfied, the move determination section 44 determines not to move data.

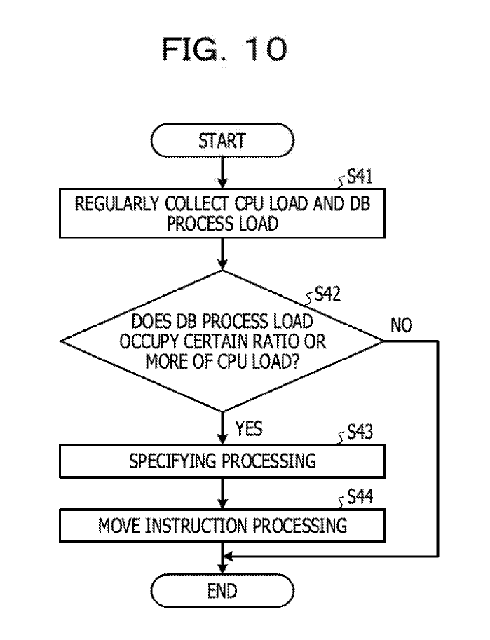

Next, a flow of processing performed by a data management device according to the second embodiment will be described. FIG. 10 is a flowchart illustrating a flow of processing performed by a data management device according to the second embodiment. As illustrated in FIG. 10, the data management device according to the second embodiment regularly collects a central processing unit (CPU) load and a DB process load (Step S41) and determines whether or not the DB process load occupies a certain ratio or more of the CPU load (Step S42).

As a result, if the DB process load does not occupy the certain ratio or more of the CPU load, the data management device according to the second embodiment terminates the processing. On the other hand, if the DB process load occupies the certain ratio or more of the CPU load, the data management device according to the second embodiment specifies the move source server 2, the move data, and the move destination server 2 and performs specifying processing of determining whether or not the move conditions are satisfied (Step S43). Then, if the move conditions are satisfied, the data management device according to the second embodiment performs move instruction processing of instructing move of data and update of the move data routing table 5 (Step S44).

As described above, if the move conditions are satisfied, the data management device according to the second embodiment performs move instruction processing, and thereby, the load of the distributed database system 1 may be reduced.

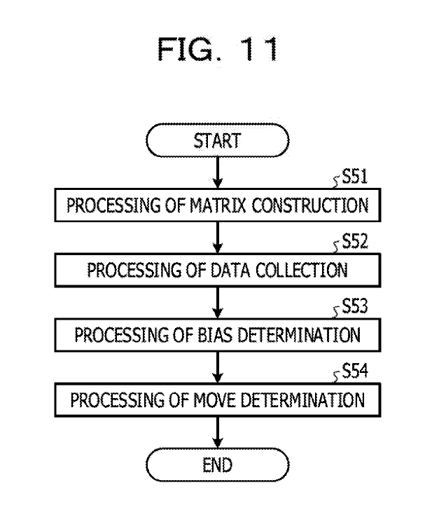

Next, a flow of processing performed by the specifying section 22a will be described. FIG. 11 is a flowchart illustrating a flow of processing performed by the specifying section 22a. As illustrated in FIG. 11, the matrix construction section 41 performs processing of matrix construction in which a matrix used for cost calculation is constructed (Step S51). Then, the data collection section 42 performs processing of data collection in which the data amount is collected from all servers 2 (Step S52).

Then, the bias determination section 43 performs processing of determining a bias of the load of each server 2 using the deviation values (Step S53). Then, if there is a bias in the load of any server 2, the move determination section 44 performs processing of move determination in which it is determined whether or not to move data (Step S54).

Thus, if there is a bias in the load of any server 2, the move determination section 44 determines whether or not to move data, and thereby, the specifying section 22a may properly move data.

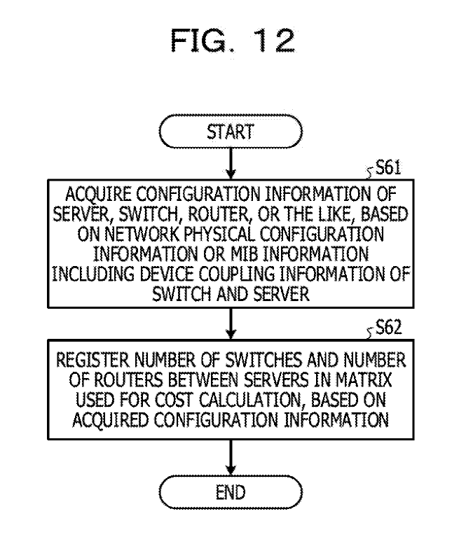

Next, a flow of processing of matrix construction will be described. FIG. 12 is a flowchart illustrating a flow of processing of matrix construction. As illustrated in FIG. 12, the matrix construction section 41 acquires configuration information of the servers 2, the switches, the routers, or the like, based on the network physical configuration information or the MIB information including device coupling information of the switches and the routers, or the like (Step S61).

Then, the matrix construction section 41 registers, based on the acquired configuration information, the number of switches between the servers 2 and the number of routers in the matrix used for cost calculation (Step S62).

As described above, the matrix construction section 41 constructs a matrix, based on the configuration information, and registers the number of switches and the number of routers in the matrix, and thereby, the specifying section 22a may perform cost calculation using the matrix.

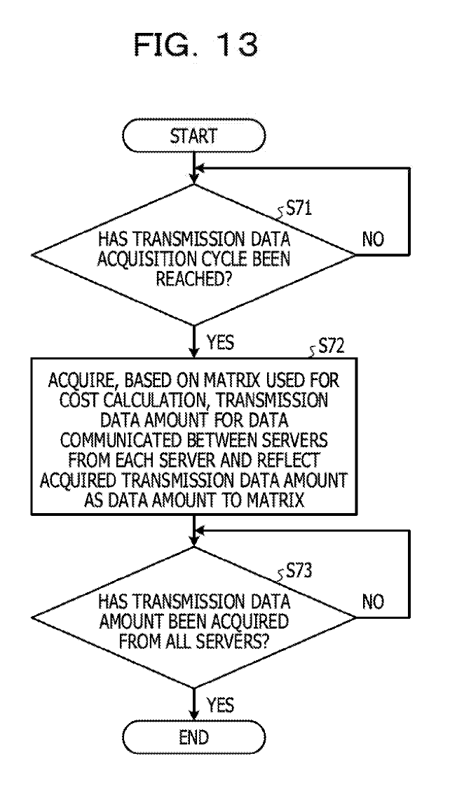

Next, a flow of processing of data collection will be described. FIG. 13 is a flowchart illustrating a flow of processing of data collection. As illustrated in FIG. 13, the data collection section 42 determines whether or not a transmission data acquisition cycle has been reached (Step S71) and repeats, if the data acquisition cycle has not been reached, the determination until the data acquisition cycle is reached.

Then, the data collection section 42 acquires, based on the matrix used for cost calculation, the transmission data amount from each server 2 for data communicated between the servers 2 and reflects the acquired transmission data amount as the data amount to the matrix (Step S72).

Then, the data collection section 42 determines whether or not the transmission data amount has been acquired from all servers 2 (Step S73), terminates, if the transmission data amount has been acquired from all servers 2, the processing, and repeats, if there is any server 2 from which the transmission data amount has not been acquired, the determination until the transmission data amount is acquired from all servers 2.

As described above, the data collection section 42 registers the data amount in the matrix, and thereby, the specifying section 22a may perform cost calculation using the matrix.

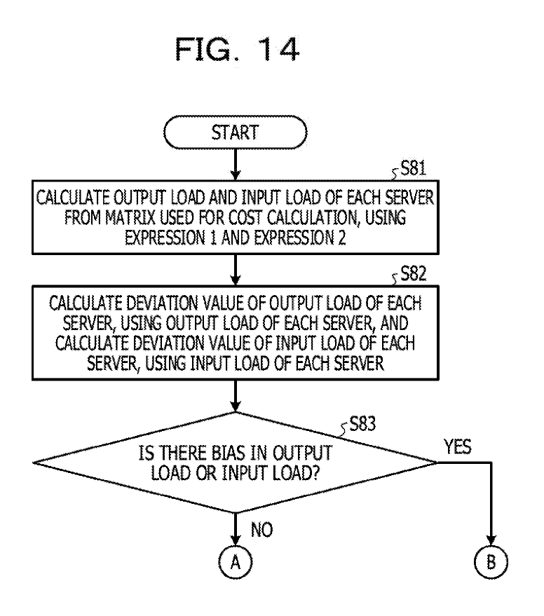

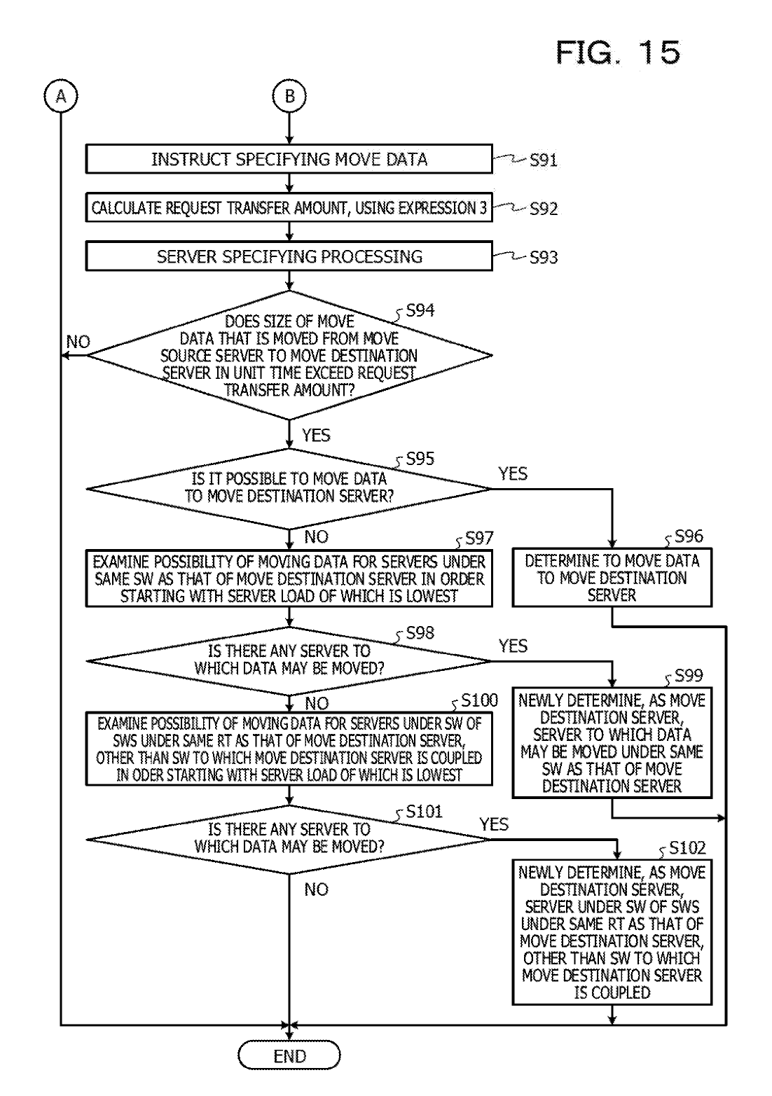

Next, a flow of bias determination processing will be described. FIG. 14 is a flowchart illustrating a flow of processing of bias determination. As illustrated in FIG. 14, the bias determination section 43 calculates the output load and the input load of each server 2 from the matrix used for cost calculation, using Expression 1 and Expression 2 in FIG. 8C (Step S81).

Then, the bias determination section 43 calculates the deviation value of the output load of each server 2, using the output load of each server 2, and calculates the deviation value of the input load of each server 2, using the input load of each server 2 (Step S82). Then, the bias determination section 43 determines, based on the deviation values, whether or not there is a bias in the output load or the input load (Step S83) and, if there is no bias therein, the specifying section 22a causes the process to proceed such that the processing of move determination illustrated in FIG. 15 is skipped. On the other hand, if there is a bias therein, the specifying section 22a causes, assuming that the server 2 the bias of which is the largest is the move source server 2 from which data is moved, the process to proceed to the processing of move determination illustrated in FIG. 15.

As described above, the bias determination section 43 determines a bias in a load, based on deviation values, and thereby, the specifying section 22a may determine the desirability of data move.

Next, a flow of processing of move determination will be described. FIG. 15 is a flowchart illustrating a flow of processing of move determination. As illustrated in FIG. 15, the move determination section 44 instructs the move source server 2 to specify move data (Step S91) and calculates the request transfer amount, using Expression 3 of FIG. 8C (Step S92).

Then, the move determination section 44 performs server specifying processing of specifying the move destination server 2 (Step S93) and determines whether or not the size of move data that is moved from the move source server 2 to the move destination server 2 in a unit time exceeds the request transfer amount (Step S94). As a result, if the size does not exceed the request transfer amount, the move determination section 44 determines to move data.

On the other hand, if the size exceeds the request transfer amount, the move determination section 44 determines, based on the capacity of the HDD of the move destination server 2, whether or not it is possible to move data to the move destination server 2 (Step S95). As a result, if it is possible to move data to the move destination server 2, the move determination section 44 determines to move data to the move destination server 2 (Step S96).

On the other hand, if it is not possible to move data to the move destination server 2, the move determination section 44 examines the possibility of moving data, for the other servers 2 under the same SW as that of the move destination server 2, in order starting with the server 2 the load of which is the lowest (Step S97). Then, the move determination section 44 determines whether or not there is any server 2 to which data may be moved (Step S98) and newly determines, if there is any server 2 to which data may be moved, the server 2 to which data may be moved under the same SW as that of the move source destination 2 as a move destination server 2 (Step S99).

On the other hand, if there is no server 2 to which data may be moved under the same SW, the move determination section 44 examines the possibility of moving data, for the other servers 2 under an SW of the SWs under the same RT as that of the move destination server 2, other than the SW to which the move destination server 2 is coupled, in order starting with the server 2 the load of which is the lowest (Step S100). Then, the move determination section 44 determines whether or not there is any server 2 to which data may be moved (Step S101). As a result, if there is any server 2 to which data may be moved, the move determination section 44 newly determines, as the move destination server 2, the server 2 to which data may be moved under an SW of the SWs under the same RT as that of the move destination server 2, other than the SW to which the move destination server 2 is coupled (Step S102). On the other hand, if there is no server 2 to which data may be moved, the move determination section 44 determines not to move data.

As described above, if it is not possible to move data to the move destination server 2 specified by server specifying processing, the move determination section 44 examines, for the other servers 2, the possibility of moving data to each of the other servers 2 under the same SW and RT as those of the move destination server 2 in order, and thereby, a proper move destination server 2 may be found. Note that, if a plurality of pieces of move data is specified in Step S91, the processing of Step S92 to Step S102 is performed on each move data piece.

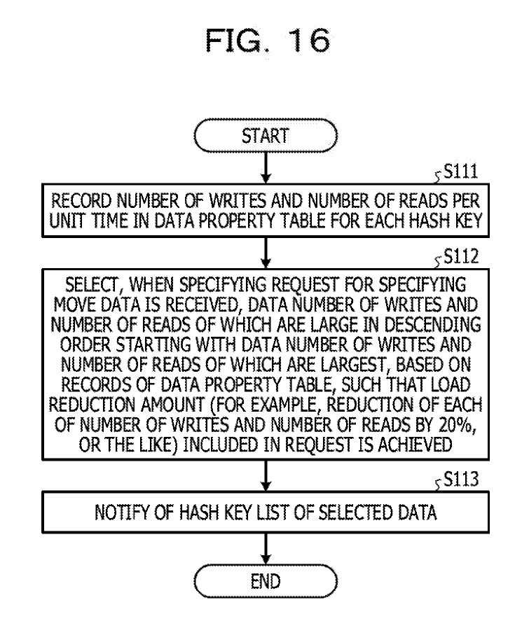

Next, a flow of processing of specifying move data will be described. FIG. 16 is a flowchart illustrating a flow of processing of specifying move data. As illustrated in FIG. 16, the server 2 records the number of writes and the number of reads per unit time in a data property table 8 for each hash key (Step S111).

Then, when receiving a specifying request for specifying move data, the server 2 selects data the number of writes and the number of reads of which are large in descending order starting with the data the number of writes and the number of reads of which are the largest, based on records of the data property table 8, such that a load reduction amount included in the request is achieved (Step S112). In this case, as for the load reduction amount included in the request, reduction of each of the number of writes and the number of reads by 20%, or the like, is designated. Then, the server 2 notifies the data management device of a hash key list of selected data (Step S113).

As described above, the server 2 records the number of writes and the number of reads per unit time in the data property table 8 for each hash key, and therefore, may specify, when receiving a move data specifying request, move data, based on the number of writes and the number of reads per unit time.

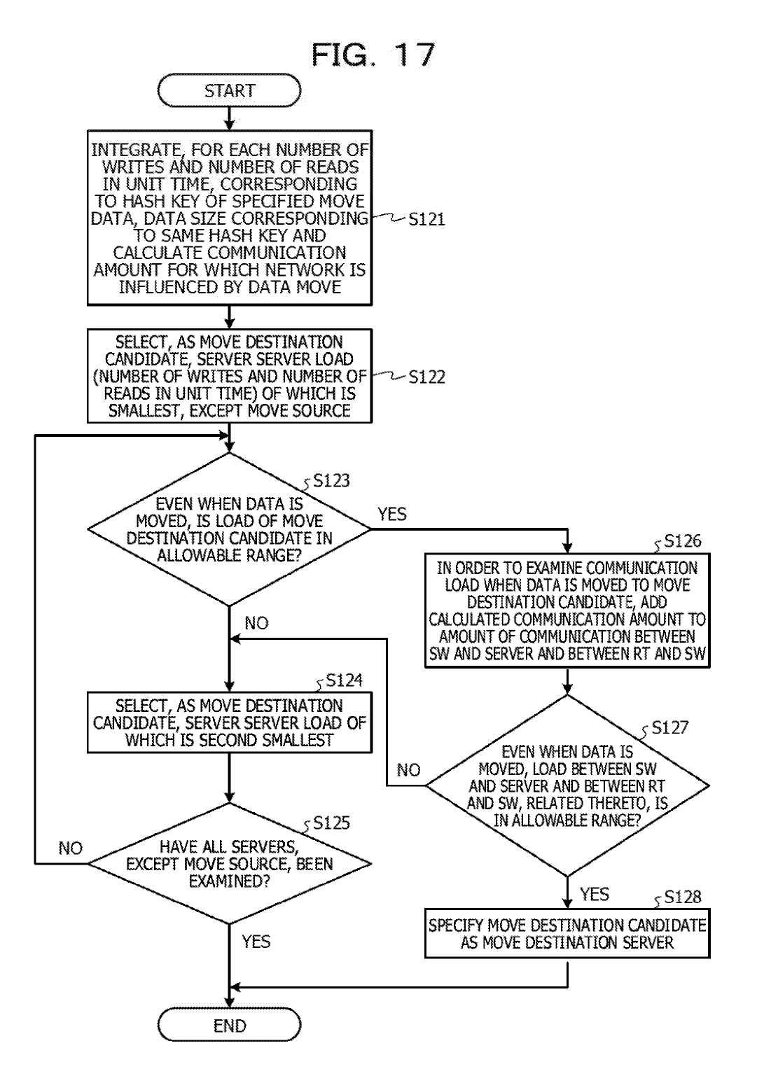

Next, a flow of server specifying processing will be described. FIG. 17 is a flowchart illustrating a flow of server specifying processing. As illustrated in FIG. 17, the move determination section 44 integrates, for each of the number of writes and the number of reads in a unit time, corresponding to a hash key of specified move data, the data size corresponding to the same hash key and calculates the communication amount with which the network 6 is influenced by data move (Step S121).

Then, the move determination section 44 selects, as a move destination candidate, the server 2 the server load of which is the smallest, except the move source (Step S122). In this case, the server load is the number of writes and the number of reads in a unit time. Then, the move determination section 44 determines whether or not, even when data is moved, the load of the move destination candidate is in an allowable range (Step S123).

As a result, if the load of the move destination candidate is not in an allowable range, the move determination section 44 selects, as a move destination candidate, the server 2 the server load of which is the next smallest (Step S124) and determines whether or not all servers 2, except the move source, have been examined (Step S125). As a result, if all servers 2, except the move source, have been examined, the move determination section 44 determines that there is no move destination server 2 and terminates the processing. On the other hand, if there is any server 2 that has not been examined, except the move source, the move determination section 44 causes the process to return to Step S123.

Also, in Step S123, if the load of the move destination candidate is in an allowable range, the move determination section 44 adds, in order to examine the communication load when data is moved to the move destination candidate, the calculated communication amount to the amount of communication between the SW and the server 2 and between the RT and the SW, related thereto (Step S126). Then, the move determination section 44 determines whether or not, even when data is moved, the amount of communication between the SW and the server 2 and between the RT and the SW, related thereto, is in an allowable range (Step S127), and, if the communication amount is not in an allowable range, the process proceeds to Step S124. On the other hand, if the communication amount is in an allowable range, the move determination section 44 specifies the move destination candidate as the move destination server 2 (Step S128).

As described above, the move determination section 44 specifies the move destination server 2, based on the server load and the communication load, and thereby, reduction in performance of the distributed database system 1 associated with data move may be reduced.

As has been described above, in the second embodiment, the specifying section 22a calculates the output load and the input load of each server 2, using the matrix used for cost calculation and specifies, based on the output load and the input load that have been calculated, the move source server 2 from which data is moved. Therefore, the specifying section 22a may properly specify the move source server 2 from which data is moved.

Also, in the second embodiment, the specifying section 22a compares the size of move data that is moved from the move source server 2 to the move destination server 2 in a unit time with the request transfer amount, and if the size is larger than the request transfer amount, the specifying section 22a determines to move data. Therefore, the specifying section 22a may reduce reduction in performance of the distributed database system 1 associated with data move.

Also, in the second embodiment, if it is not possible to move data to the move destination server 2 specified by server specifying processing, the specifying section 22a specifies a new move destination server 2 in the order of the server 2 under the same SW as that of the move destination server 2 and the server 2 under the same RT as that of the move destination server 2. Therefore, the server 2 in a closest communication environment to that of the move destination server 2 that has been specified by server specifying processing may be set as a new move destination server 2.

### THIRD EMBODIMENT

In the second embodiment, a case where the performance of the distributed database system 1 is increased by moving data of the server 2 the load of which is the highest to another server 2 has been described. As another alternative, the performance of the distributed database system 1 may be increased by putting pieces of low-load data with fewer accesses together. Then, in a third embodiment, processing of moving low-load data will be described. Note that a data management device according to the third embodiment will be hereinafter referred to merely as a data management device.

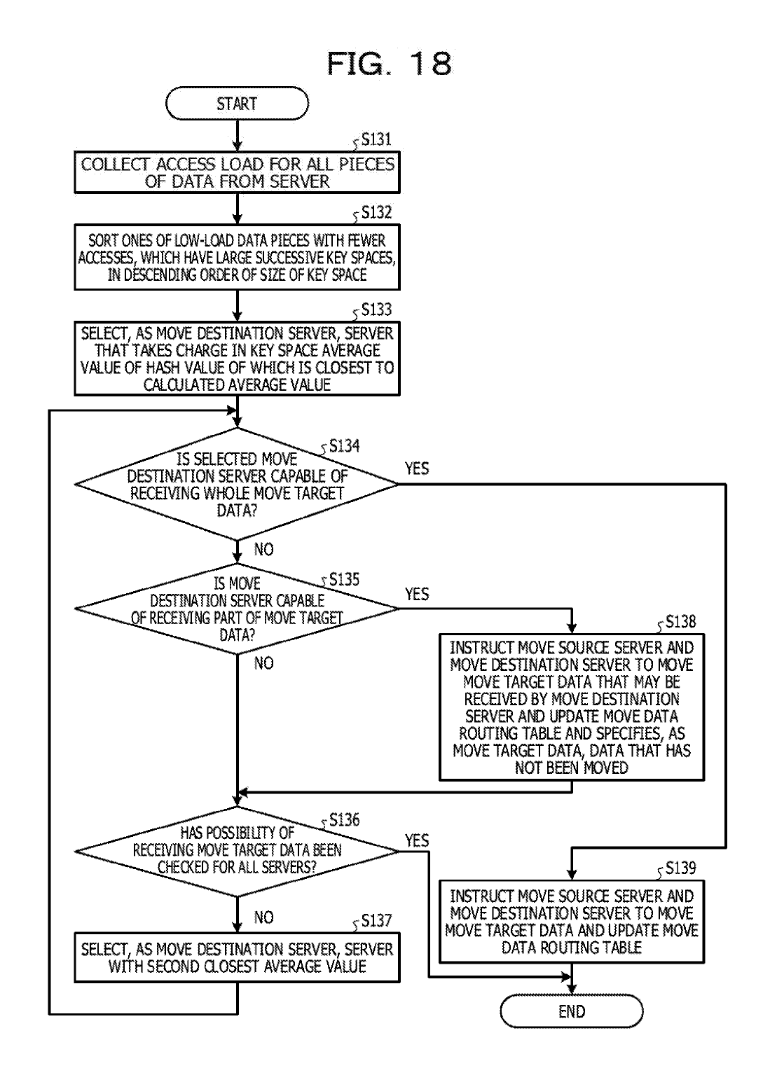

FIG. 18 is a flowchart illustrating a flow of low-load data move processing. As illustrated in FIG. 18, the data management device collects access loads for all pieces of data from the servers 2 (Step S131). Then, the data management device sorts ones of low-load data pieces with fewer accesses, which have large successive key spaces, in descending order of the size of the key space (Step S132). The low-load data used herein is, for example, data to which a smaller number of accesses than a predetermined threshold have been made.

Then, the data management device sets data included in the largest one of the successive key spaces as move target data. Then, the data management device calculates an average value of the hash value of the key space of the move target data and selects, as a move destination server 2, the server 2 that takes charge of the key space the average value of the hash value of which is the closest to the calculated average value (Step S133). The move source server 2 from which the move target data is moved is excluded from the move destination server 2.

Then, the data management device determines whether or not the selected move destination server 2 is capable of receiving the whole move target data (Step S134) and determines, if the move destination server 2 is not capable of receiving the whole move target data, whether or not the move destination server 2 is capable of receiving a part of the move target data (Step S135). As a result, if the move destination server 2 is not capable of receiving even a part of the move target data, the data management device determines whether or not a possibility of receiving the move target data has been checked for all the servers 2 (Step S136). As a result, if the possibility of receiving the move target data has been checked for all the servers 2, the data management device terminates the processing and, if there is any server 2 for which the possibility of receiving the move target data has not been checked, the data management device selects, as the move destination server 2, the server 2 with the second closest averaged value to the calculated average value (Step S137) and causes the process to return to Step S134.

On the other hand, if the move destination server 2 is capable of receiving a part of the move target data, the data management device instructs the move source server 2 and the move destination server 2 to move the move target data that may be received by the move destination server 2 and update the move data routing table 5. Then, the data management device specifies, as move target data, data that has not been moved (Step S138) and causes the process to proceed to Step S136.

Also, if the selected move destination server 2 is capable of receiving the whole move target data, the data management device instructs the move source server 2 and the move destination server 2 to move the move target data and update the move data routing table 5 (Step S139).

As has been described above, in the third embodiment, the data management device is capable of putting low-load data together by moving, as move target data, low-load data included in the largest one of the successive key spaces, and the performance of the distributed database system 1 may be increased.

Note that, although, in each of the first to third embodiments, the data management device has been described, a data management program having a similar function may be achieved by realizing a configuration of the data management device with a software. Therefore, a computer that executes the data management program will be described.

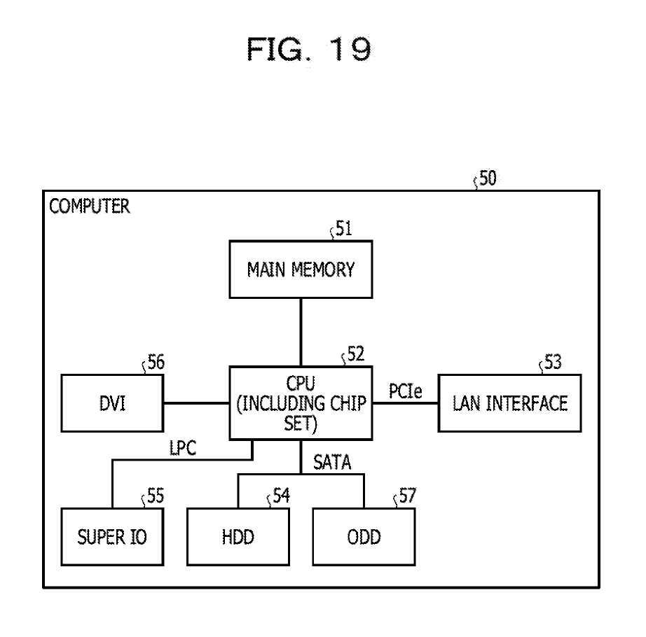

FIG. 19 is a diagram illustrating a hardware configuration of a computer that executes a data management program according to an embodiment. As illustrated in FIG. 19, a computer 50 includes main memory 51, a CPU 52, a LAN interface 53, and an HDD 54. The computer 50 also includes a super input output (IO) 55, a digital visual interface (DVI) 56, and an optical disk drive (ODD) 57.

The main memory 51 is memory that stores a program and an execution intermediate result of the program. The CPU 52 is a central processing unit that reads the program from the main memory 51 and executes the program. The CPU 52 includes a chip set including a memory controller.

The LAN interface 53 is an interface used for coupling the computer 50 to another computer via a LAN. The HDD 54 is a disk device that stores a program and data and the super IO 55 is an interface used for coupling an input device, such as a mouse, a keyboard, or the like. The DVI 56 is an interface used for coupling a liquid crystal display device, and the ODD 57 is a device that reads and writes data from and to a DVD.

The LAN interface 53 is coupled to the CPU 52 via a PCI express (PCIe) and the HDD 54 and the ODD 57 are coupled to the CPU 52 via a serial advanced technology attachment (SATA). The super IO 55 is coupled to the CPU 52 via a low pin count (LPC).

Then, the data management program executed by the computer 50 is stored in a DVD, is read from the DVD by the ODD 57, and is installed in the computer 50. As another alternative, the data management program is stored in a database of another computer system, or the like, coupled to the computer 50 via the LAN interface 53, is read from the database or the like, and is installed in the computer 50. Then, the installed data management program is stored in the HDD 54, is read to the main memory 51, and is executed by the CPU 52.

Also, although, in each of the first to third embodiments, the data management device has been described, a server 2 that manages data or another server 2 included in a cloud system may be configured to execute a data management program and thereby have a function of the data management device.

Also, although, in each of the first to third embodiments, the distributed database system in which, using key and value pairs, data is managed by a plurality of servers in a decentralized manner has been described, in the distributed database system, data having another configuration may be managed by a plurality of servers in a decentralized manner.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A management device of a storage system in which a plurality of pieces of data is stored in a plurality of devices respectively, the management device comprising:
a memory; and
a processor coupled to the memory and configured to:
acquire access information indicating access statuses to the plurality of pieces of data stored in the plurality of devices respectively,
determine, based on the access information, first data of the plurality of pieces of data, which is to be moved from a first device of the plurality of devices to a second device of the plurality of devices,
move the first data from the first device to the second device,
register, in the first device, move data information that specifies the first data and move destination device information that specifies the second device, and
register, in the second device, the move data information and move source device information that specifies the first device.

2. The management device according to claim 1, wherein
a key value is allocated to each of the plurality of pieces of data,
a range of the key value is allocated to each of the plurality of devices, and
each of the plurality of devices stores corresponding data of the plurality of pieces of data, which has the key value included in the range.

3. The management device according to claim 2, wherein
the first data has a first key value, and
the first key value is included in the range allocated to the first device.

4. The management device according to claim 3, wherein the processor is further configured to:
specify, when an access request for the first data is received, the first device that corresponds to the range including the first key value from the plurality of devices, based on the first key value allocated to the first data, and
transmit the access request to the first device.

5. The management device according to claim 4, wherein the first device is configured to transfer, to the second device, the access request transmitted from the management device, based on the move data information and the move destination device information.

6. The management device according to claim 5, wherein the second device is configured to:
receive the access request from the first device, and
output the first data, based on the move data information and the move source device information.

7. The management device according to claim 1, wherein the processor is configured to determine, as the first data, the data which is specified by the access information, the access frequency of which is equal to or more than a certain value.

8. The management device according to claim 7, wherein the processor is configured to determine the first data, based on the data size of the data specified by the access information.

9. The management device according to claim 1, wherein the processor is configured to:
determine an output load and an input load of each of the plurality of devices, and
determine the first device which corresponds to a load of the output loads and the input loads which is a highest value.

10. The management device according to claim 5, wherein the processor is configured to move the first data when a first load used for transferring the access request from the first device to the second device is smaller than a second load used for moving the first data from the first device to the second device.

11. The management device according to claim 1, wherein the plurality of devices are configured to be coupled to each other via a plurality of switches, and
the processor is configured to:
specify, when it is determined based on the data capacity of the second device that the first data is not to be moved to the second device, a first switch of the plurality of switches, to which the second device is coupled, and
move the first data to a third device of the plurality of devices, which is coupled to the first switch.

12. The management device according to claim 11, wherein the plurality of devices are configured to be coupled to each other via a plurality of routers, and
the processor is configured to:
specify, when it is determined based on the data capacity of the third device that the first data is not to be moved to the third device, a first router of the plurality of routers, to which the second device is coupled, and a second switch of the plurality of switches, which is coupled to the first router, and
move the first data to a fourth device of the plurality of devices, which is coupled to the second switch.

13. The management device according to claim 7, wherein the processor is configured to move the plurality of pieces of data when the total data size of the plurality of pieces of data the access frequency of which is less than a threshold is equal to or more than a value.

14. A method executed by a management device configured to manage a storage system in which a plurality of pieces of data is stored in a plurality of devices respectively, the method comprising:
acquiring access information indicating access statuses to the plurality of pieces of data stored in the plurality of devices respectively;
determining, based on the access information, first data of the plurality of pieces of data, which is to be moved from a first device of the plurality of devices to a second device of the plurality of devices;
moving the first data from the first device to the second device;
registering, in the first device, move data information that specifies the first data and move destination device information that specifies the second device; and
registering, in the second device, the move data information and move source device information that specifies the first device.

15. The method according to claim 14, further comprising:
allocating a key value to each of the plurality of pieces of data;
allocating a range of the key value to each of the plurality of devices; and
storing, in each of the plurality of devices, the corresponding one of the plurality of pieces of data, which has the key value included in the range.

16. The method according to claim 15, wherein
the first data has a first key value, and
the first key value is included in the range allocated to the first device.

17. The method according to claim 16, further comprising:
specifying, when an access request for the first data is received, the first device that corresponds to the range including the first key value from the plurality of devices, based on the first key value allocated to the first data; and
transmitting the access request to the first device.

18. A non-transitory computer-readable storage medium storing a program that causes an information processing apparatus to execute a process, the information processing apparatus being configured to manage a storage system in which a plurality of pieces of data is stored in a plurality of devices respectively, the process comprising:
acquiring access information indicating access statuses to the plurality of pieces of data stored in the plurality of devices respectively;
determining, based on the access information, first data of the plurality of pieces of data, which is to be moved from a first device of the plurality of devices to a second device of the plurality of devices;
moving the first data from the first device to the second device;
registering, in the first device, move data information that specifies the first data and move destination device information that specifies the second device; and
registering, in the second device, the move data information and move source device information that specifies the first device.

19. The non-transitory computer-readable storage medium according to claim 18, the process further comprising:
allocating a key value to each of the plurality of pieces of data;
allocating a range of the key value to each of the plurality of devices; and
storing, in each of the plurality of devices, the corresponding one of the plurality of pieces of data, which has the key value included in the range.

20. The non-transitory computer-readable storage medium according to claim 19, wherein
the first data has a first key value, and
the first key value is included in the range allocated to the first device.
